(19) United States
(12) Patent Application Publication
(10) Pub. No.: US 2017/0347021 A1
(43) Pub. Date: Nov. 30, 2017

(54) OPERATION DEVICE AND OPERATION SYSTEM

(71) Applicant: Olympus Corporation, Tokyo (JP)

(72) Inventor: Sumio Kawai, Tokyo (JP)

(21) Appl. No.: 15/597,530

(22) Filed: May 17, 2017

(30) Foreign Application Priority Data
May 24, 2016 (JP) 2016-103533

(51) Int. Cl. H04N 5/232; G06F 3/045; G06F 3/01

(52) U.S. Cl. CPC H04N 5/23216; H04N 5/23203; G06F 3/014; G06F 3/045; G06F 2203/04105

(57) ABSTRACT

An operation device includes: a detector adapted for being mounted at least to a thumb or an index finger, and configured to detect changes in flexion with time at a joint and in pressing with time at a tip of the thumb or the index finger; a recording unit configured to record operation information representing association between: each of the change in flexion and the change in pressing; and operations performed by any of the thumb and the index finger on an external device; a determination unit configured to determine the operation included in the operation information, based on the change in flexion and the change in pressing; and a control unit configured to generate a control signal for causing the external device to perform a predetermined operation, according to the determined operation, and transmit the control signal to the external device.

### CROSS-REFERENCE TO RELATED APPLICATIONS

This application is based upon and claims the benefit of priority from Japanese Patent Application No. 2016-103533, filed on May 24, 2016, the entire contents of which are incorporated herein by reference.

### BACKGROUND

The present disclosure relates to an operation device and an operation system.

In the related art, to acquire surface profile data or movement data of a hand or finger, an operation device operating a manipulator or the like uses a glove formed of an electrical insulation material into the shape of a human hand to detect change in resistance value of the electrical insulation material, which changes in response to movement of the hand or finger, and detects flexion or movement of the hand or finger (for example, see JP 2000-329511 A).

Furthermore, to detect movement or a posture of a human body, a piezoelectric element provided at a bending portion of clothes or a glove is used to detect an electric potential generated in response to the movement of the human body, and detects the movement or posture of the human body (for example, see JP 2003-5887 A or JP 2012-213818 A).

### SUMMARY

An operation device according to one aspect of the present disclosure includes: a detector adapted for being mounted at least to a thumb or an index finger, and configured to detect a change in flexion with time at a joint and a change in pressing with time at a tip of the thumb or the index finger wearing the detector; a recording unit configured to record operation information representing association between: each of the change in flexion and the change in pressing; and a plurality of operations performed by any of the thumb and the index finger on an external device; a determination unit configured to determine the operation included in the operation information recorded in the recording unit, based on the change in flexion and the change in pressing; and a control unit configured to generate a control signal for causing the external device to perform a predetermined operation, according to the determined operation, and transmit the control signal to the external device.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a front view of an operation device in an operation system according to a first embodiment of the present disclosure;

FIG. 2 is a back side view of the operation device of the operation system according to the first embodiment of the present disclosure;

FIG. 3A is a block diagram illustrating a functional configuration of the operation system according to the first embodiment of the present disclosure;

FIG. 3B is a block diagram illustrating a functional configuration of the operation system according to the first embodiment of the present disclosure;

FIG. 4 is a plan view of a first bending detector according to the first embodiment of the present disclosure;

FIG. 5 is a cross-sectional view taken along a line V-V of FIG. 4;

FIG. 6A is a diagram illustrating an example of displacement of the first bending detector according to the first embodiment of the present disclosure;

FIG. 6B is a diagram illustrating an example of displacement of the first bending detector according to the first embodiment of the present disclosure;

FIG. 7A is a diagram illustrating an example of displacement of a first pressing detector according to the first embodiment of the present disclosure;

FIG. 7B is a diagram illustrating an example of displacement of the first pressing detector according to the first embodiment of the present disclosure;

FIG. 7C is a diagram illustrating an example of displacement of the first pressing detector according to the first embodiment of the present disclosure;

FIG. 8 is a graph illustrating change in sensor voltage detected by the first pressing detector according to the first embodiment of the present disclosure;

FIG. 9 is a graph illustrating change in sensor voltage detected by the first bending detector according to the first embodiment of the present disclosure;

FIG. 10 is a schematic flowchart illustrating a process performed by the operation device according to the first embodiment of the present disclosure;

FIG. 11A is a schematic view illustrating movement of the detectors according to the first embodiment of the present disclosure;

FIG. 11B is a schematic view illustrating movement of the detectors according to the first embodiment of the present disclosure;

FIG. 12 is a schematic flowchart illustrating a process performed by an imaging device according to the first embodiment of the present disclosure;

FIG. 13 is a front view of an operation device according to a modification of the first embodiment of the present disclosure;

FIG. 14 is a front view of an operation device of an operation system according to a second embodiment of the present disclosure;

FIG. 15A is a block diagram illustrating a functional configuration of the operation system according to the second embodiment of the present disclosure;

FIG. 15B is a block diagram illustrating a functional configuration of the operation system according to the second embodiment of the present disclosure;

FIG. 16 is a schematic flowchart illustrating a process performed by the operation device according to the second embodiment of the present disclosure;

FIG. 17 is a schematic flowchart illustrating a process performed by an imaging device according to the second embodiment of the present disclosure;

FIG. 18 is a schematic diagram illustrating a configuration of an operation system according to a third embodiment of the present disclosure;

FIG. 19A is a block diagram illustrating a functional configuration of the operation system according to the third embodiment of the present disclosure;

FIG. 19B is a block diagram illustrating a functional configuration of the operation system according to the third embodiment of the present disclosure;

FIG. 20 is a plan view of a first sensor according to a modification of the first to third embodiments of the present disclosure;

FIG. 21 is a cross-sectional view taken along a line A-A of FIG. 20;

FIG. 22 is a cross-sectional view taken along a line B-B of FIG. 20; and

FIG. 23 is a schematic view illustrating movement of a first sensor according to a modification of the first to third embodiments of the present disclosure;

### DETAILED DESCRIPTION

Modes for carrying out the present disclosure (hereinafter, referred to as “embodiments”) will be described below in detail with reference to the drawings. It should be understood that the present disclosure is not limited to the following embodiments. Furthermore, the drawings referred to in the following description are merely schematically illustrated in shape, size, and positional relationship so that the contents of the present disclosure may be understood. That is, the present disclosure is not limited only to the shapes, sizes, and positional relationships exemplified in the drawings.

### First Embodiment

Configuration Outline of Operation System

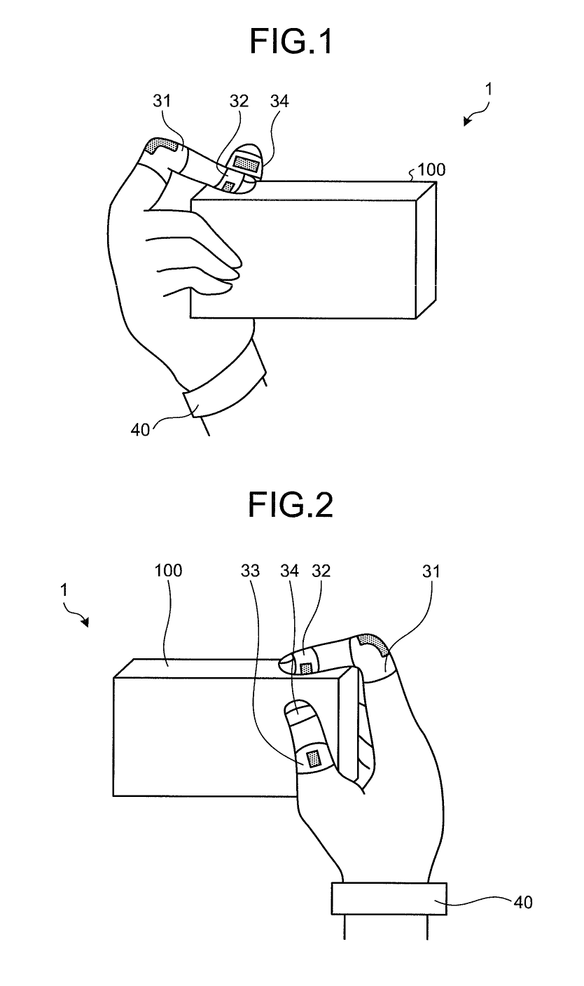

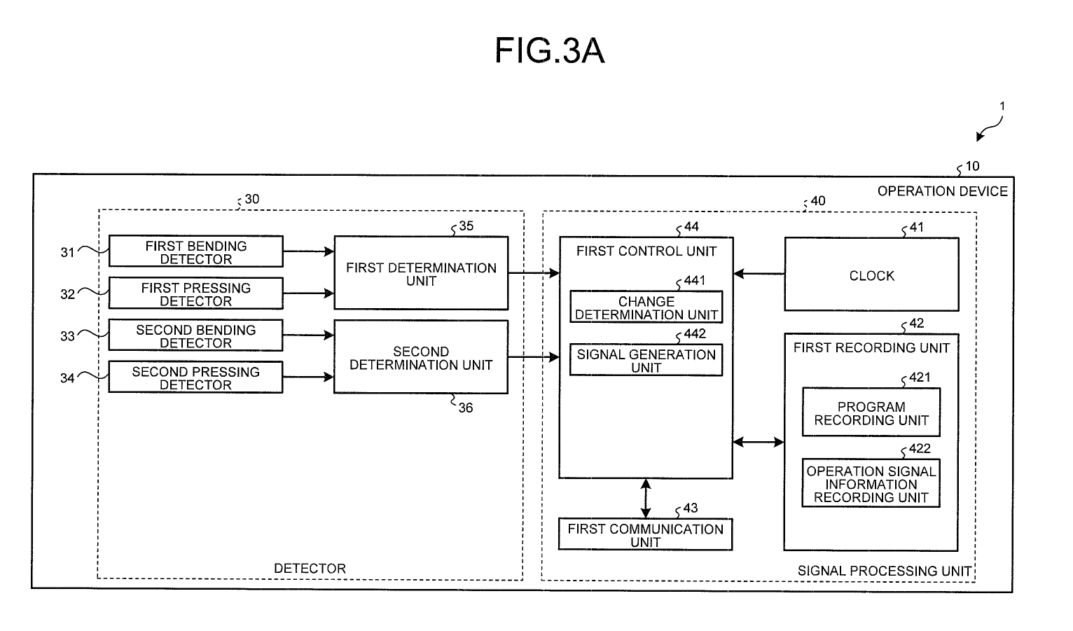

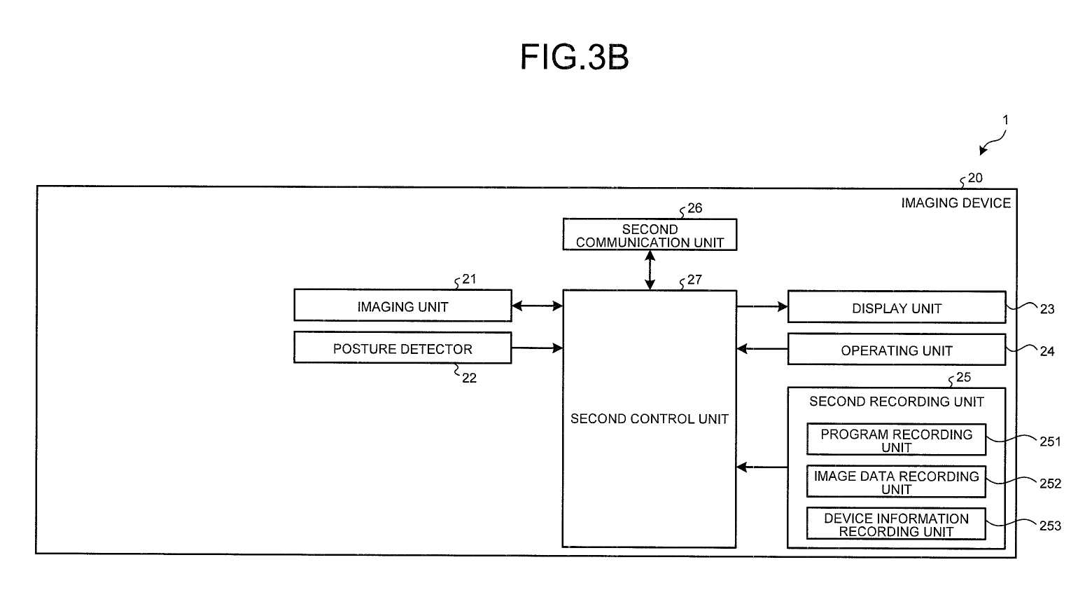

FIG. 1 is a front view of an operation device in an operation system according to a first embodiment of the present disclosure. FIG. 2 is a back side view of the operation device of the operation system according to the first embodiment of the present disclosure. FIGS. 3A and 3B are block diagrams illustrating functional configurations of the operation system according to the first embodiment of the present disclosure.

An operation system 1 illustrated in FIGS. 1, 2, 3A, and 3B includes an operation device 10 mounted to a user, and transmitting a signal according to the movement of a user's finger, and an imaging device 20 capable of capturing an image based on the signal transmitted from the operation device 10. The operation device 10 is mounted to a user's hand, finger, wrist, or the like. The imaging device 20 is mounted to any of glasses, a helmet, a cap, and clothes of the user, an automobile or a bicycle of the user, a radio-controllable drone, or the like. As a matter of course, the imaging device 20 may be installed at a remote place separated from the user, or may be mounted on a tripod. Furthermore, the user wearing the operation device 10 virtually operates the imaging device 20 to a dummy 100 to be operated. The dummy 100 to be operated preferably is a rectangular object such as a cellular phone, a card, a bag, a box, or a pencil case, different from the imaging device 20, and may be a user's arm. The dummy 100 to be operated may be just virtually operated, and not necessarily required.

Furthermore, the operation device 10 and the imaging device 20 are connected to bidirectionally communicate with each other over a predetermined frequency range (frequency range according to a wireless standard of each country, e.g., 27 MHz, 40 MHz, 72 MHz, 73 MHz, 2.4 GHz, 5 GHz, or 5.8 GHz). Note that, connection between the operation device 10 and the imaging device 20 is not limited to wireless connection, and may be wired connection enabling bidirectional communication using a cable or the like.

Configuration of Operation Device

First, a configuration of the operation device 10 will be described.

The operation device 10 includes: a detector 30 mounted to user's thumb and finger(s), and detecting change in flexion of a joint of the user's thumb or finger and change in pressing by the user's thumb or finger; and a signal processing unit 40 generating a control signal causing the imaging device 20 to perform a predetermined operation, based on a detection result from the detector 30, and transmitting the control signal.

First, the detector 30 will be described.

The detector 30 includes a first bending detector 31, a first pressing detector 32, a second bending detector 33, a second pressing detector 34, a first determination unit 35, and a second determination unit 36.

As illustrated in FIGS. 1 and 2, the first bending detector 31 is mounted to the second joint of a user's index finger (second digit). The first bending detector 31 detects a change in flexion of the joint of the index finger, when the user moves the index finger in operation to the dummy 100 to be operated.

As illustrated in FIGS. 1 and 2, the first pressing detector 32 is mounted to a tip of a user's index finger (distal phalanx or nail). The first pressing detector 32 detects a change in pressing of the user's index finger, when the user presses the tip of the index finger in operation to the dummy 100 to be operated.

As illustrated in FIGS. 1 and 2, the second bending detector 33 is mounted to the first joint of a user's thumb (first digit). The second bending detector 33 detects a change in flexion of the joint of the thumb, when the user moves the thumb in operation to the dummy 100 to be operated.

As illustrated in FIGS. 1 and 2, the second pressing detector 34 is mounted to a tip of a user's thumb (distal phalanx or nail). The second pressing detector 34 detects a change in pressing of the thumb, when the user moves the thumb in operation to the dummy 100 to be operated.

The first determination unit 35 is each connected to the first bending detector 31 and the first pressing detector 32 in a wired or wireless manner, determines the change (a change in state) in flexion of the joint and in pressing of the tip of the index finger, based on a signal input from the first bending detector 31 and a signal input from the first pressing detector 32, and outputs this determination result to a first control unit 44.

The second determination unit 36 is each connected to the second bending detector 33 and the second pressing detector 34 in a wired or wireless manner, determines the change (a change in state) in flexion of the joint and in pressing of the tip of the thumb, based on a signal input from the second bending detector 33 and a signal input from the second pressing detector 34, and outputs this determination result to the first control unit 44.

Next, the signal processing unit 40 will be described.

The signal processing unit 40 includes a clock 41, a first recording unit 42, a first communication unit 43, and the first control unit 44.

The clock 41 has a clock function and clocks time, and outputs this result to the first control unit 44.

The first recording unit 42 records various information about the operation device 10. The first recording unit 42 includes a program recording unit 421 configured to record various programs executed by the operation device 10, and an operation signal information recording unit 422 configured to record operation information representing association between a plurality of devices, a plurality of operations performed in each of the plurality of devices, and each of the change in flexion with time at the joints and the change in pressing with time at the tips.

The first communication unit 43 transmits predetermined information input from the first control unit 44 to the imaging device 20, and outputs information received from the imaging device 20 to the first control unit 44, under the control of the first control unit 44.

The first control unit 44 controls each unit of the operation device 10. The first control unit 44 includes a change determination unit 441 and a signal generation unit 442.

The change determination unit 441 determines an operation included in the operation information recorded in the operation signal information recording unit 422, based on the change in flexion of the joints and the change in pressing of the tips detected by the detector 30.

The signal generation unit 442 generates a control signal being a control signal causing the imaging device 20 to perform a predetermined operation, according to the operation determined by the change determination unit 441, and transmits the control signal to the imaging device 20.

Configuration of Imaging Device

Next, a configuration of the imaging device 20 will be described.

The imaging device 20 includes an imaging unit 21, a posture detector 22, a display unit 23, an operating unit 24, a second recording unit 25, a second communication unit 26, and a second control unit 27.

The imaging unit 21 images an object and generates image data, and outputs the image data to the second control unit 27, under the control of the second control unit 27. The imaging unit 21 includes an optical system including one or more lenses, a diaphragm, a shutter, and an imaging element such as a charge coupled device (CCD) or a complementary metal oxide semiconductor (CMOS).

The posture detector 22 detects a posture of the imaging device 20, and transmits this detection result to the second control unit 27. The posture detector 22 includes an acceleration sensor, a gyroscope sensor, or the like.

The display unit 23 displays an image corresponding to image data generated by the imaging unit 21, under the control of the second control unit 27. The display unit 23 includes a liquid crystal display panel, an organic electro luminescence (EL) display panel, or the like.

The operating unit 24 receives input of various signals to the imaging device 20. The operating unit 24 includes a plurality of switches, an operation ring provided to rotate an optical axis of the optical system of the imaging unit 21, and a jog dial.

The second recording unit 25 records various information and image data of the imaging device 20. The second recording unit 25 includes a flash memory, a synchronous dynamic random access memory (SDRAM), or a memory card. The second recording unit 25 includes a program recording unit 251 configured to record a program executed by the imaging device 20, an image data recording unit 252 configured to record image data generated by the imaging unit 21, and a device information recording unit 253 configured to record device information about the imaging device 20.

The second communication unit 26 transmits predetermined information input from the first control unit 44 to the imaging device 20, and outputs information received from the imaging device 20 to the second control unit 27, under the control of the second control unit 27.

The second control unit 27 includes a central processing unit (CPU) or the like, and controls each unit of the imaging device 20. Furthermore, the second control unit 27 performs control according to an operation signal received through the second communication unit 26. Furthermore, the second control unit 27 transmits the device information about the imaging device 20 to the operation device 10, through the second communication unit 26.

Configuration of First Bending Detector

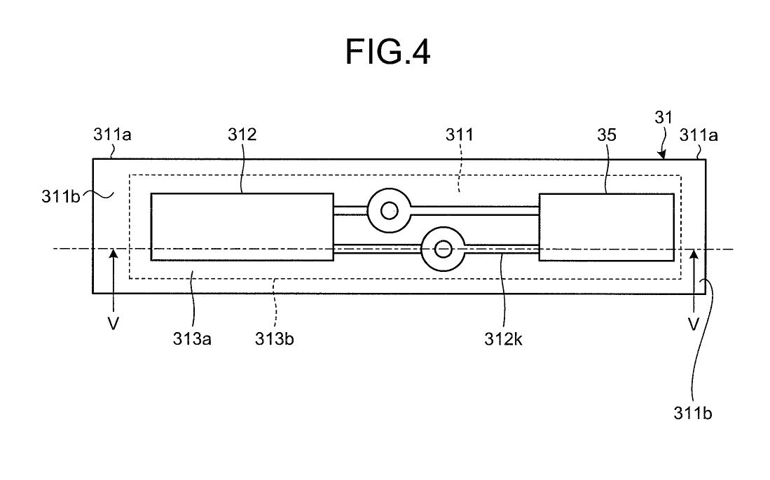

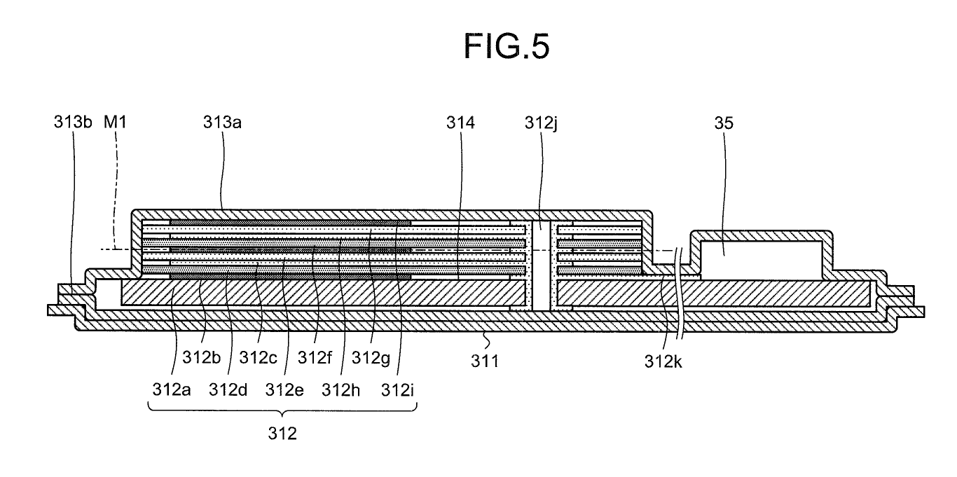

Next, a configuration of the first bending detector 31 will be described in detail. FIG. 4 is a plan view of the first bending detector 31. FIG. 5 is a cross-sectional view taken along a line V-V of FIG. 4. Note that since the first pressing detector 32, the second bending detector 33, and the second pressing detector 34 have a configuration similar to that of the first bending detector 31, and the first bending detector 31 is representatively described below.

As illustrated in FIGS. 4 and 5, the first bending detector 31 includes a first mounted portion 311, a first sensor unit 312, a substrate portion 314, and protective sheet portions 313a and 313b. The first sensor unit 312, the substrate portion 314, and the protective sheet portions 313a and 313b include a plurality of flexible sheet materials as described later, and the sheets are joined into a flexible laminated sheet having a thickness of approximately 0.1 mm. This flexible laminated sheet is applied to the first mounted portion 311. Furthermore, the first mounted portion 311 may be used instead of one of the protective sheet portions 313a and 313b, and may not be separately provided.

The first mounted portion 311 has a sheet shape. The first mounted portion 311 includes a stretchable resin sheet or the like. The first mounted portion 311 has longitudinal both end portions 311a, and each of both end portions 311a is provided with a connection portion 311b. The connection portion 311b includes for example a hook-and-loop fastener or an adhesive tape. Note that the connection portion 311b may be coated with an adhesive, or may have a magnet or the like, as long as the connection portion 311b may be wound around the user's finger or user's finger joint. As a matter of course, the first mounted portion 311 may have a fingerstall shape or a ring shape, in addition to the sheet shape. In this configuration, the first mounted portion 311 includes an elastic member such as rubber.

The first sensor unit 312 includes a first GND electrode 312a including a flexible insulation sheet material and formed on the substrate portion 314, a first poly-D-lactic acid sheet portion 312b including poly-D-lactic acid having piezoelectricity, a first poly-L-lactic acid sheet portion 312c including poly-L-lactic acid having piezoelectricity, an electroconductive first detection electrode 312d configured to detect voltage generated in the first poly-D-lactic acid sheet portion 312b and the first poly-L-lactic acid sheet portion 312c, a second GND electrode 312e, a second poly-D-lactic acid sheet portion 312f including poly-D-lactic acid having piezoelectricity, a second poly-L-lactic acid sheet portion 312g including poly-L-lactic acid having piezoelectricity, an electroconductive second detection electrode 312h configured to detect voltage generated in the second poly-D-lactic acid sheet portion 312f and the second poly-L-lactic acid sheet portion 312g, and a third GND electrode 312i. The first sensor unit 312 is obtained by laminating the first GND electrode 312a, the first poly-D-lactic acid sheet portion 312b, the first detection electrode 312d, the first poly-L-lactic acid sheet portion 312c, the second GND electrode 312e, the second poly-D-lactic acid sheet portion 312f, the second detection electrode 312h, the second poly-L-lactic acid sheet portion 312g, and the third GND electrode 312i, in this order.

Furthermore, as illustrated in FIG. 5, the first sensor unit 312 has a first detection layer on one side (vertical lower side), and a second detection layer on the other side (vertical upper side), relative to a neutral axis M1 of bending. Furthermore, the first GND electrode 312a, the second GND electrode 312e, the third GND electrode 312i, the first detection electrode 312d, and the second detection electrode 312h are electrically connected on an inner peripheral side of a through-hole 312j, and further connected to the first determination unit 35, through a lead wire 312k formed on the substrate portion 314. The first determination unit 35 is connected to a communication module not illustrated, and the communication module transmits a determination result from the first determination unit 35 to the signal processing unit 40.

The protective sheet portions 313a and 313b seals and covers the first sensor unit 312, the first determination unit 35, and the substrate portion 314 to prevent intrusion of rain or dust into the first sensor unit 312. The protective sheet portions 313a and 313b include an elastic sheet, a resin sheet, or the like.

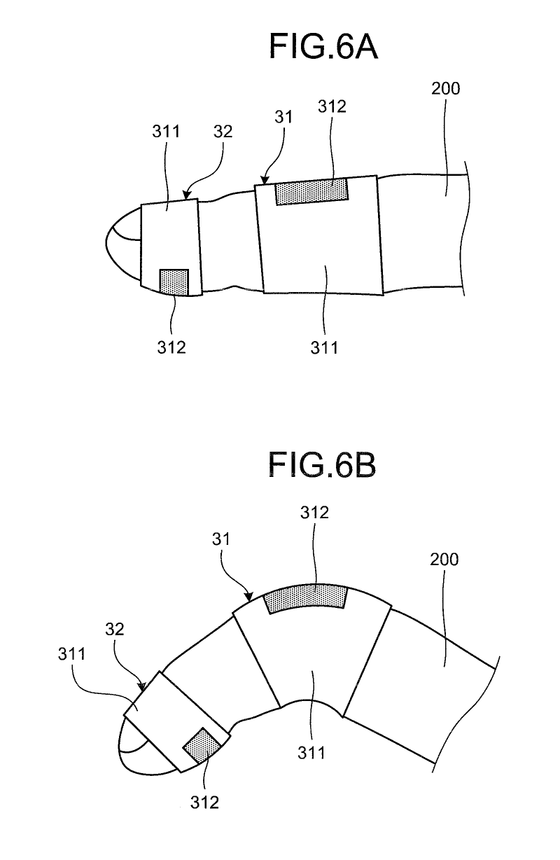

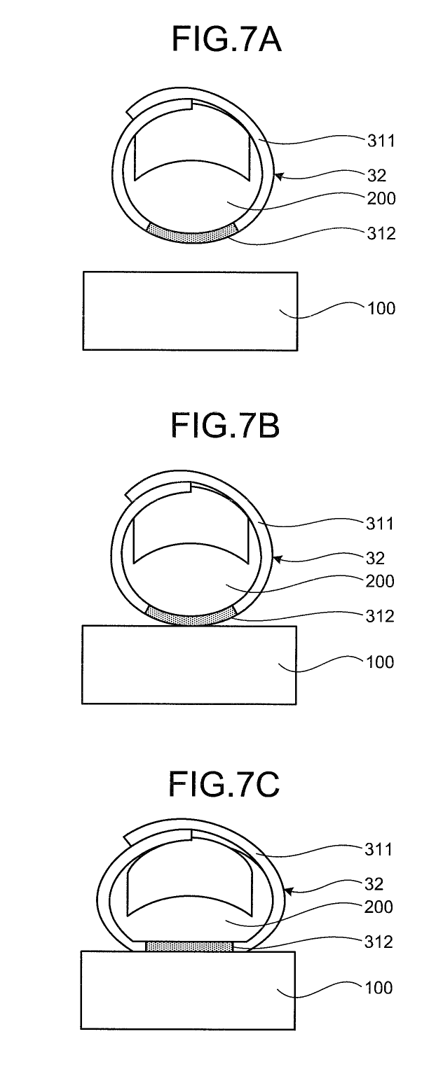

As illustrated in FIG. 6A, the first bending detector 31 configured as described above is mounted to the joint of a user's finger 200. Furthermore, as illustrated in FIG. 6A, the first pressing detector 32 is mounted to the tip of the user's finger 200. Accordingly, as illustrated in FIGS. 6A and 6B, when the user bends the finger 200 (index finger), the first bending detector 31 is stretched and bent into the shape of the finger 200, electrical charge is generated in the first sensor unit 312 according to the degree of tension and curvature, and a voltage signal is generated through an electrode (the first GND electrode 312a, the second GND electrode 312e, the third GND electrode 312i). Furthermore, in the first pressing detector 32, when the user performs touch operation or push operation on the dummy 100 to be operated, the first sensor unit 312 is stretched and bent, electrical charge is generated in the first sensor unit 312, and a voltage signal is generated through an electrode, as illustrated in FIGS. 7A to 7C. When there is no subsequent displacement of the first sensor unit 312, the generated electrical charge discharges with time, and the voltage signal decreases.

Change in Voltage of First Pressing Detector

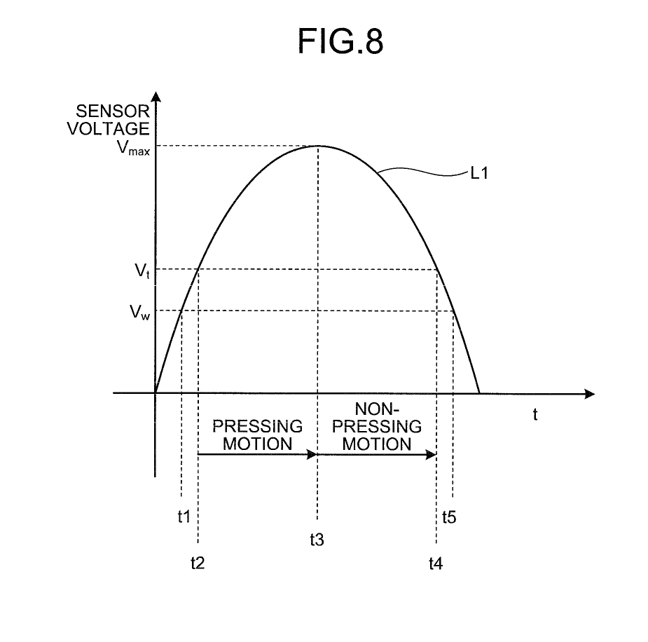

Next, voltage detected by the first pressing detector 32 will be described. FIG. 8 is a diagram illustrating change in sensor voltage detected by the first pressing detector 32. In FIG. 8, the vertical axis represents voltage, and the horizontal axis represents time. Furthermore, in FIG. 8, a curved line L1 represents change in voltage signal detected by the first pressing detector 32.

As indicated by the curved line L1 illustrated in FIG. 8, while the first pressing detector 32 is mounted on the user's finger, the first pressing detector 32 is stretched and bent, and sensor voltage Vw is output (see time point t1). Then, as illustrated above in FIGS. 7A to 7C, when the user starts touching the dummy 100 to be operated (time t2), the sensor voltage detected by the first pressing detector 32 reaches Vt. Upon a maximum compression state as illustrated in FIG. 7C (time t3), the sensor voltage detected by the first pressing detector 32 reaches Vmax. Then, at a time point (time t4) at which the user removes the index finger from the dummy 100 to be operated and finishes touching, the sensor voltage detected by the first pressing detector 32 reaches Vt, and then reaches Vw being the sensor voltage while the first pressing detector 32 is mounted to the user's finger (time point t5). That is, in the first pressing detector 32, when the user presses the dummy 100 to be operated, the sensor voltage gradually increases with time, and then as the user performs operation for separation from the dummy 100 to be operated, the voltage gradually decreases, and returns to the sensor voltage Vw which is the voltage while the first pressing detector 32 is mounted. Thus, the change determination unit 441 determines an operation included in the operation information recorded in the operation signal information recording unit 422, based on a change in sensor voltage with time, detected by the first pressing detector 32. In this case, for example the change determination unit 441 determines the operation as the push operation. Note that FIG. 8 illustrates the sensor voltage without consideration of discharge of the electrical charge, but the discharge of the electrical charge changes at a predetermined rate per time, and the amount of electrical charge discharged may be corrected based on time to calculate the sensor voltage value corresponding to the pressing motion of FIG. 8.

Change in Voltage of First Bending Detector

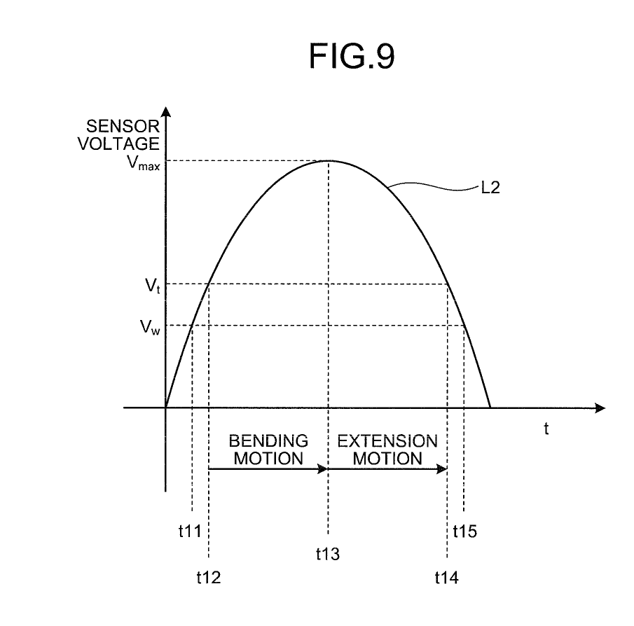

Next, sensor voltage detected by the first bending detector 31 will be described. FIG. 9 is a graph illustrating change in sensor voltage detected by the first bending detector 31. In FIG. 9, the vertical axis represents sensor voltage, and the horizontal axis represents time. Furthermore, in FIG. 9, a curved line L2 represents change in voltage signal detected by the first bending detector 31.

As indicated by the curved line L2 illustrated in FIG. 9, the first bending detector 31 being mounted on the joint of the user's finger outputs sensor voltage Vw (time point t11). Then, as illustrated above in FIGS. 6A and 6B, in the first bending detector 31, when the user starts bending the finger (time t12), the sensor voltage detected by the first bending detector 31 reaches Vt (time point t13). At the point of maximum curvature, the sensor voltage detected by the first bending detector 31 reaches Vmax. Then, in the first bending detector 31, at a time point (time t14) at which the user extends the finger and finishes bending thereof, the sensor voltage detected by the first bending detector 31 reaches Vt, and then reaches Vw being the sensor voltage while the first bending detector 31 is mounted to the user's finger (time point t15). That is, in the first bending detector 31, when the user bends the fingers, the sensor voltage gradually increases with time, and then as the user returns the finger, the sensor voltage gradually decreases, and returns to the sensor voltage Vw which is the voltage while the first bending detector 31 is mounted. Thus, the change determination unit 441 determines an operation included in the operation information recorded in the operation signal information recording unit 422, based on a change in sensor voltage with time, detected by the first bending detector 31. Furthermore, discharge of the electrical charge may be corrected similarly to that of the first pressing detector 32, for further accurate determination. For example, when the change in sensor voltage with time is within the range of bending motion of FIG. 9, the change determination unit 441 determines the operation as flexion operation. Furthermore, when a change in voltage with time, detected by the first pressing detector 32, and a change in sensor voltage with time, detected by the first bending detector 31, each have a predetermined value, the change determination unit 441 determines that release operation is performed on an external device being the imaging device 20. More specifically, information about a correspondence relationship between the change in sensor voltage with time and the release operation is previously stored in the operation signal information recording unit 422, and the release operation is determined based on this information.

Process Performed by Operation Device

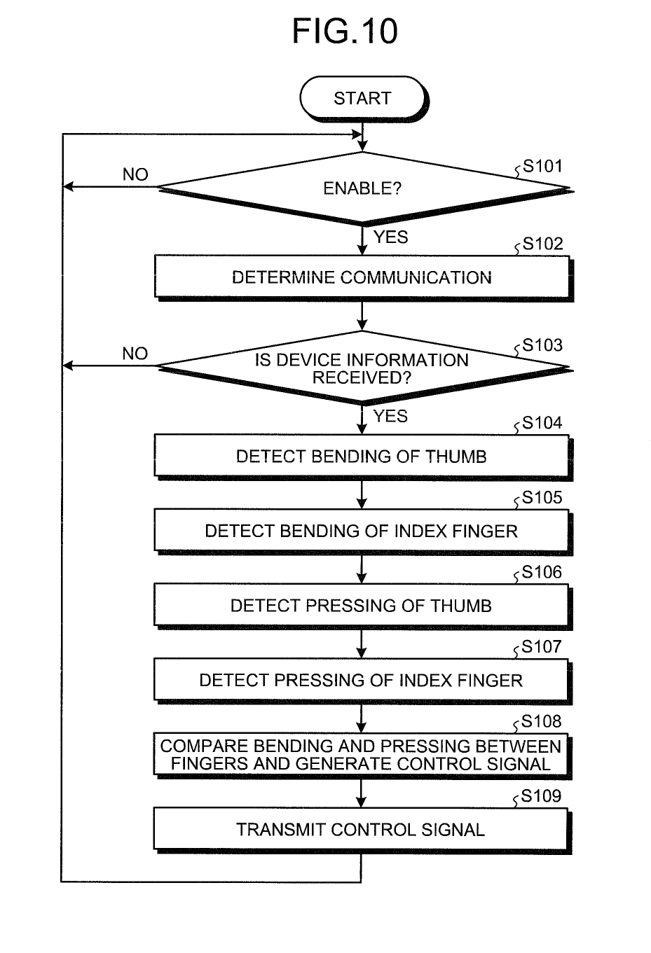

Next, a process performed by the operation device 10 will be described. FIG. 10 is a schematic flowchart illustrating the process performed by the operation device 10.

As illustrated in FIG. 10, first of all, communication enabled between the operation device 10 and the imaging device 20 (step S101: Yes) will be described. In this configuration, the first control unit 44 determines communication of the first communication unit 43 (step S102), receives the device information for identification of the imaging device 20 from the imaging device 20 through the first communication unit 43 (step S103: Yes), and proceeds to step S104.

Next, the detector 30 detects bending of the thumb (step S104) and bending of the index finger (step S105).

Then, the detector 30 detects pressing of the thumb (step S106) and pressing of the index finger (step S107).

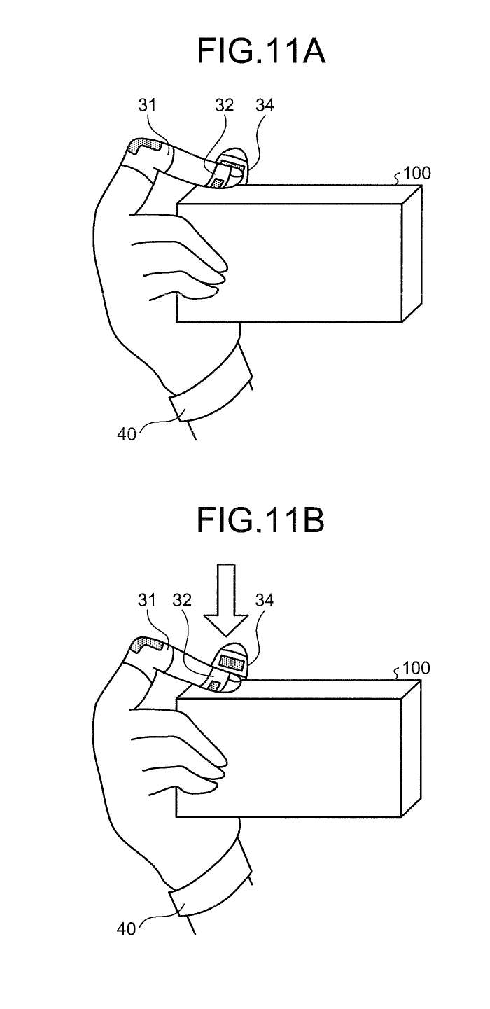

Next, the change determination unit 441 refers to the operation information recorded in the operation signal information recording unit 422 to determine a control signal corresponding to an operation, based on the change in flexion of the joint of each of the thumb and the index finger, detected by the detector 30, and the change in pressing of the tip of each of the thumb and the index finger (step S108). For example, as illustrated in FIGS. 11A and 11B, when there are no change in flexion of the joint of the thumb and no change in pressing of the tip of the thumb, and the change in pressing of the tip of the index finger has a value not smaller than a predetermined value in a predetermined time period, the change determination unit 441 determines the release operation (push operation by the index finger), and determines a control signal for instructing the imaging device 20 to perform the release operation, for the imaging device 20.

Then, the signal generation unit 442 transmits the control signal causing the imaging device 20 to perform the operation according to the operation determined by the change determination unit 441, through the first communication unit 43 (step S109). After step S109, the operation device 10 returns to step S101.

In step S101, when communication is not enabled between the operation device 10 and the imaging device 20 (step S101: No), the operation device 10 repeats this determination.

In step S103, when the device information for identification of the imaging device 20 is not received from the imaging device 20 (step S103: No), the operation device 10 returns to step S101.

Process Performed by Imaging Device

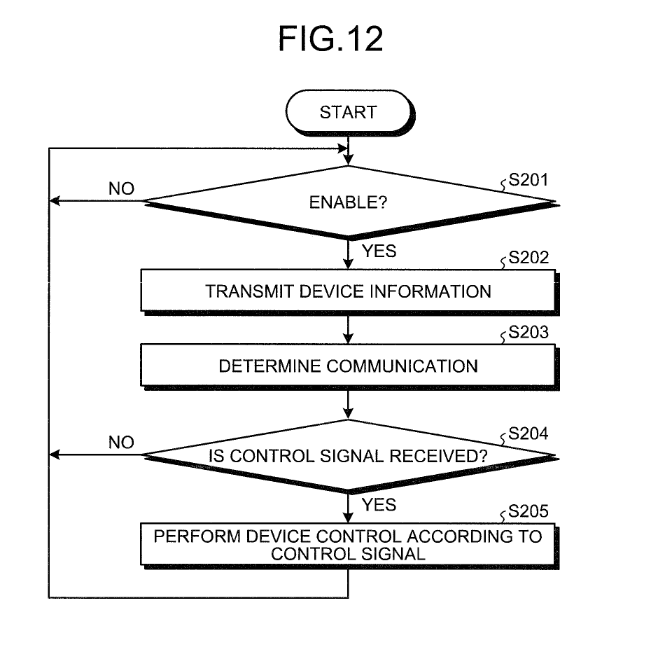

Next, a process performed by the imaging device 20 will be described. FIG. 12 is a schematic flowchart illustrating the process performed by the imaging device 20.

As illustrated in FIG. 12, first of all, communication enabled between the imaging device 20 and the operation device 10 (step S201: Yes) will be described. In this configuration, the second control unit 27 transmits the device information for identification of the imaging device 20, recorded in the device information recording unit 253 to the operation device 10, through the second communication unit 26 (step S202).

Then, the second control unit 27 determines communication of the second communication unit 26 (step S203), and when receiving the control signal from the operation device 10 through the second communication unit 26 (step S204: Yes), the second control unit 27 performs device control according to the control signal (step S205). For example, when the control signal received from the operation device 10 through the second communication unit 26 is the control signal for instruction of the release operation, the second control unit 27 causes the imaging unit 21 to capture an image. Furthermore, when the control signal received from the operation device 10 through the second communication unit 26 is a control signal for instruction of change of an image capture parameter (ISO speed, diaphragm value, shutter speed, focus position, exposure value) of the imaging unit 21, the second control unit 27 performs control for changing the image capture parameter of the imaging unit 21. After step S205, the imaging device 20 returns to step S201.

In step S201, when communication is not enabled between the imaging device 20 and the operation device 10 (step S201: No), the imaging device 20 repeats this determination.

In step S204, when receiving no control signal from the operation device 10 through the second communication unit 26 (step S204: No), the imaging device 20 returns to step S201.

According to the first embodiment of the present disclosure described above, the operation system is configured so that the detector 30 mounted to the thumb and the index finger, has a simple configuration, and is mounted regardless of the physical type of the user, and thus versatility may be increased.

Furthermore, according to the first embodiment of the present disclosure, the signal generation unit 442 generates the control signal being the control signal causing the imaging device 20 to perform the predetermined operation, according to the operation determined by the change determination unit 441, and transmits the control signal to the imaging device 20. Thus, simulated operation not making the user discomfort, providing tactile sensation, and corresponding to a device may cause the imaging device 20 to perform operation according to a content of operation performed by the user. Thus, when a familiar device is employed, intuitive operation thereof leads to indirect operation of the external device.

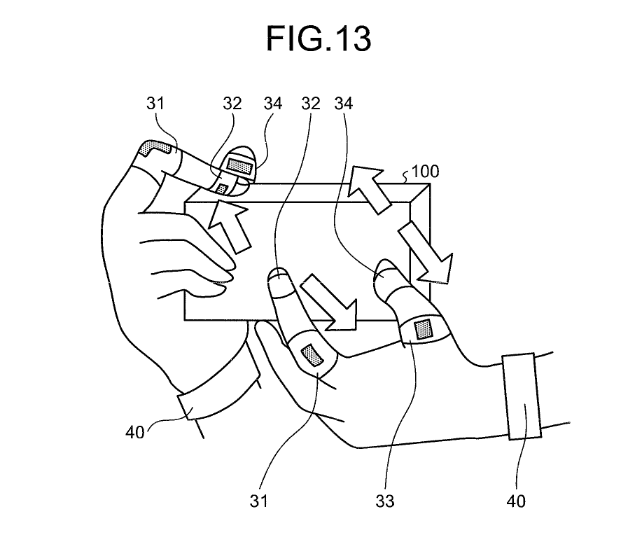

Note that, in the first embodiment described above, the operation device 10 is mounted only to one hand of the user, but the operation device 10 may be mounted to both hands of the user, for example as illustrated in FIG. 13. In this configuration, when the external device transmitting the control signal is the imaging device 20, and where a change occurs first in pressing of a tip of a left thumb and a tip of a left index finger (touching the dummy 100 to be operated with the left hand), a change occurs next in pressing of at least one of the tip of the left thumb and the tip of the left index finger, and a change occurs in flexion of at least one of a joint of the left thumb and a joint of the left index finger, in the detector 30, a change determination unit 441 of an operation device 10 mounted to the left hand determines the changes as rotation operation for clockwisely rotating a focus ring or a zoom ring of a lens barrel of the imaging unit 21 of the imaging device 20. Furthermore, when the external device transmitting the control signal is the imaging device 20, and where a change occurs in pressing of the tip of the left thumb and the tip of the left index finger, a change occurs next in flexion of at least one of the joint of the thumb and the joint of the index finger, and a change occurs in pressing of at least one of the tip of the left thumb and the tip of the left index finger, in the detector 30, the change determination unit 441 of the operation device 10 mounted to the left hand determines the changes as rotation operation for clockwisely or counterclockwisely rotating the focus ring or the zoom ring of the lens barrel of the imaging unit 21 of the imaging device 20. The rotation direction is determined by whether the change in pressing of the fingers of the hand touching the dummy 100 to be operated is changed to which of bending and extension of the respective fingers. For example, in FIG. 13, the change to the bending of the left thumb represents clockwise rotation operation, and the change to the extension of the left thumb represents counterclockwise operation. In contrast, the change to the extension of the left index finger represents the clockwise rotation operation, and the change to the bending of the left index finger represents counterclockwise operation.

### Second Embodiment

Next, a second embodiment of the present disclosure will be described. In the first embodiment described above, the change in flexion of the joint and the change in pressing of the tip of each of the thumb and the index finger are determined for determination of the operation to the external device, and the control signal is transmitted to the external device, but in the second embodiment, a change in flexion of a joint and a change in pressing of a tip of each of the user's fingers are transmitted to an external device, and the external device determines a control signal in the external device, based on a content received from an operation device, and controls each unit. In the following, after description of a configuration of an operation system according to the second embodiment, a process performed by the operation system will be described. Note that the same configurations as those of the operation system 1 according to the first embodiment are denoted by the same reference signs, and description thereof will be omitted.

Configuration Outline of Operation System

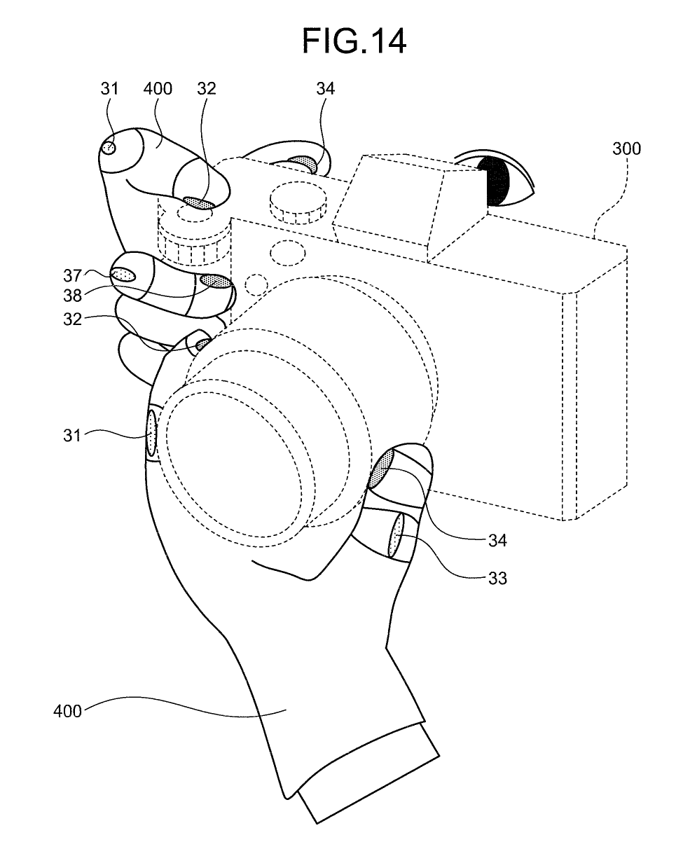

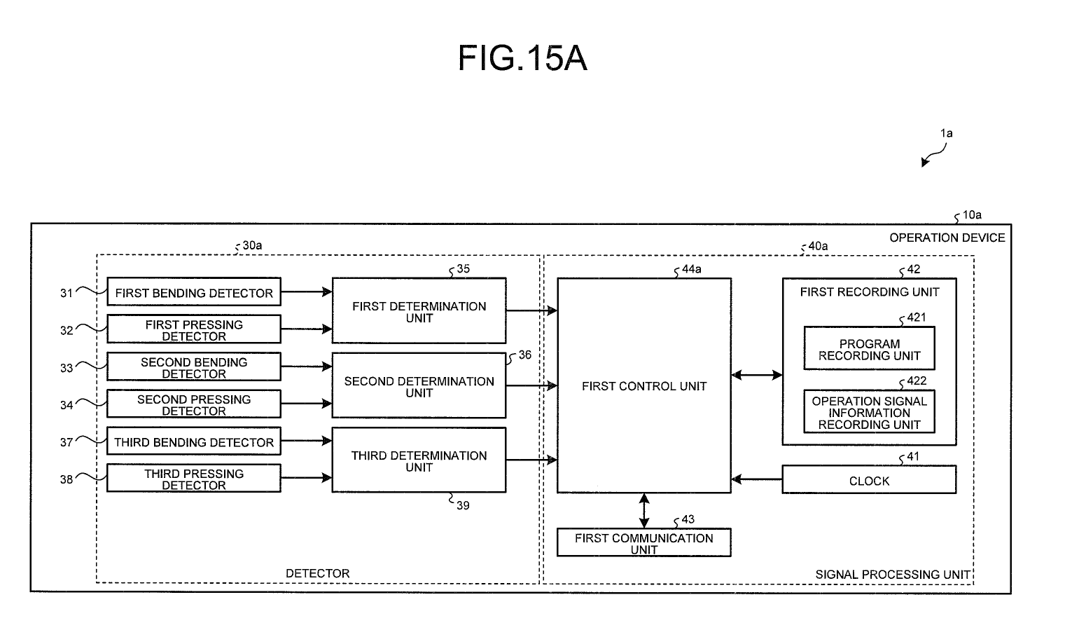

FIG. 14 is a front view of the operation device of the operation system according to the second embodiment of the present disclosure. FIGS. 15A and 15B are block diagrams illustrating functional configurations of the operation system according to the second embodiment of the present disclosure.

An operation system 1a illustrated in FIGS. 14, 15A, and 15B includes an operation device 10a mounted to the user, and transmitting a signal representing detection of movement of the user's fingers to a dummy 300 shaped in a camera or the like, and an imaging device 20a capable of capturing an image based on the signal transmitted from the operation device 10a. The operation device 10a is mounted while the user wears gloves 400.

Configuration of Operation Device

First, a configuration of the operation device 10a will be described.

The operation device 10a includes a detector 30a and a signal processing unit 40a, instead of the detector 30 and the signal processing unit 40 of the operation device 10 according to the first embodiment described above.

The detector 30a further includes a third bending detector 37 mounted to a joint of a user's middle finger (second joint portion), a third pressing detector 38 mounted to a tip of the middle finger, and a third determination unit 39, in addition to the configuration of the detector 30 according to the first embodiment described above.

The third bending detector 37 is mounted to the second joint of the user's middle finger (third digit), and detects a change in flexion of the joint of the middle finger.

The third pressing detector 38 is mounted to the tip of the user's middle finger, and detects a change in pressing of the tip of the middle finger.

The third determination unit 39 is each connected to the third bending detector 37 and the third pressing detector 38 in a wired or wireless manner, determines a state of the middle finger, based on a signal input from the third bending detector 37 and a signal input from the third pressing detector 38, and outputs this determination result to a first control unit 44a.

The signal processing unit 40a includes the first control unit 44a, instead of the first control unit 44 according to the first embodiment described above.

The first control unit 44a controls each unit of the operation device 10a. The first control unit 44a transmits a detection result detected by the detector 30a to the imaging device 20a through the first communication unit 43.

Configuration of Imaging Device

Next, a configuration of the imaging device 20a will be described. The imaging device 20a includes a second control unit 27a, instead of the second control unit 27 according to the first embodiment described above.

The second control unit 27a includes a CPU or the like and controls each unit constituting the imaging device 20a. The second control unit 27a includes a change determination unit 271.

The change determination unit 271 determines operation in the imaging device 20a, based on the change in flexion of the joints and the change in pressing of the tips, detected by the detector 30a and received through the second communication unit 26.

A signal generation unit 272 generates a control signal being a control signal causing the imaging device 20a to perform a predetermined operation, according to the operation determined by the change determination unit 271, and controls each unit of the imaging device 20a.

Process Performed by Operation Device

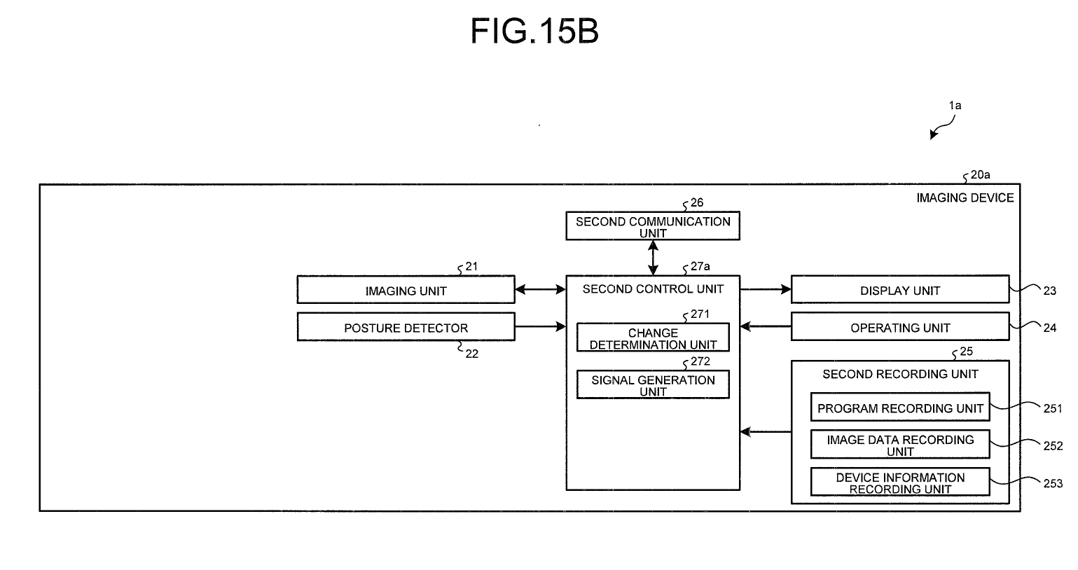

Next, a process performed by the operation device 10a will be described. FIG. 16 is a schematic flowchart illustrating the process performed by the operation device 10a. In FIG. 16, steps S301 and S302 to S305 respectively correspond to steps S101 and S104 to S107 of FIG. 10 illustrated above.

In step S306, the detector 30a detects bending of the middle finger. Then, the detector 30a detects pressing of the middle finger (step S307).

The first control unit 44a thereafter determines signals representing the flexion and pressing of each finger detected by the detector 30a (step S308), and transmits flexion (bending) and pressing signals to the imaging device 20a, through the first communication unit 43 (step S309). After step S309, the operation device 10a returns to step S301.

Process Performed by Imaging Device

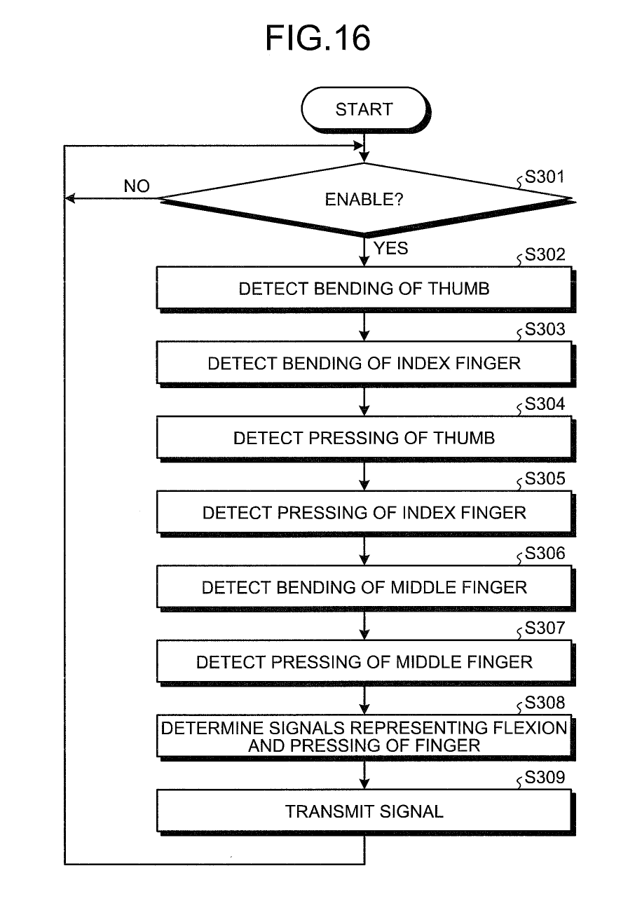

Next, a process performed by the imaging device 20a will be described. FIG. 17 is a schematic flowchart illustrating the process performed by the imaging device 20a. In FIG. 17, steps S401 and S402 respectively correspond to steps S201 and S203 of FIG. 12 illustrated above.

In step S403, when receiving the flexion (bending) and pressing signals from the operation device 10a (step S403: Yes), the second control unit 27a analyzes the signals representing the flexion and pressing, received from the operation device 10a, to control the imaging device 20a (step S404). Specifically, the change determination unit 271 determines operation in the imaging device 20a, based on the change in flexion of the joints and the change in pressing of the tips, detected by the detector 30a and received through the second communication unit 26, and the signal generation unit 272 generates a control signal according to the operation determined by the change determination unit 271, and controls each unit of the imaging device 20a. After step S404, the imaging device 20a returns to step S401.

In step S403, when receiving no flexion (bending) and pressing signals from the operation device 10a (step S403: No), the imaging device 20a returns to step S401.

According to the second embodiment of the present disclosure described above, the operation system has a simple configuration, and has an improved fit.

Furthermore, according to the second embodiment of the present disclosure, when the imaging device 20 is operated in a cold climate area in winter, by the user wearing the gloves 400 to operate the imaging device 20a, the operation device 10a may be mounted through each glove 400, and even under the condition where operation to an operating member such as an operation button or an operation dial is considerably difficult, operation may be accurately performed.

Furthermore, in the second embodiment of the present disclosure, the operation device 10a may be incorporated into the glove 400.

### Third Embodiment

Next, a third embodiment of the present disclosure will be described. The third embodiment is different from the first embodiment described above in configuration. In the following, a configuration of an operation system according to the third embodiment will be described. Note that the same configurations as those of the operation system 1 according to the first embodiment are denoted by the same reference signs, and description thereof will be omitted.

Configuration Outline of Operation System

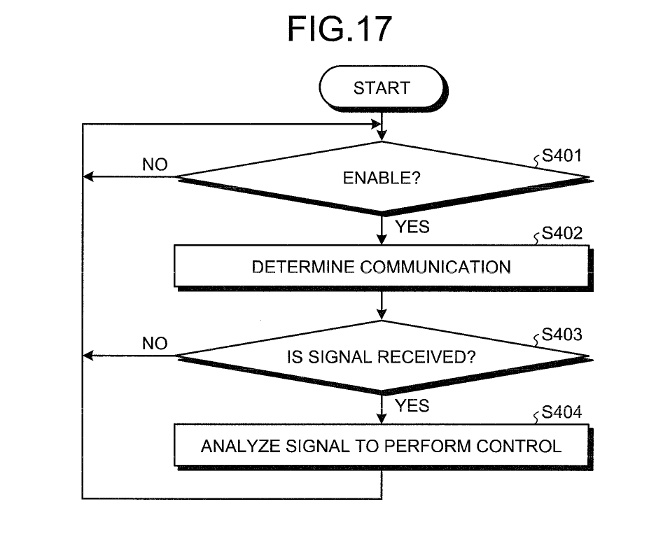

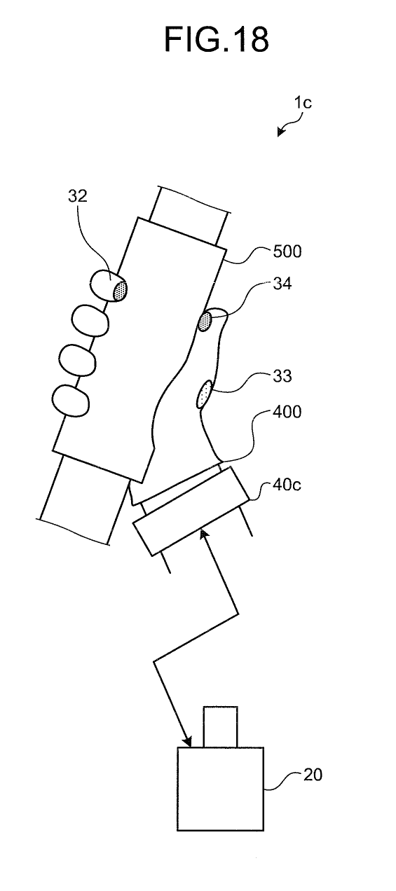

FIG. 18 is a schematic diagram illustrating a configuration of an operation system according to a third embodiment of the present disclosure. FIGS. 19A and 19B are block diagrams illustrating functional configurations of the operation system according to the third embodiment of the present disclosure.

An operation system 1c illustrated in FIGS. 18, 19A, and 19B is configured assuming that the operation system 1c is used while the user rides a bicycle or a motor cycle, holding a handlebar 500 as a dummy to be operated. In this configuration, the imaging device 20 of the operation system 1c is mounted to a bicycle or a motor cycle, or a helmet or glasses of the user.

The operation system 1c illustrated in FIGS. 18, 19A, and 19B includes an operation device 10c, instead of the operation device 10 according to the first embodiment described above. The operation device 10c includes a detector 30c mounted to a user's finger, and detecting change in flexion of a user's finger joint and in pressing by the user's finger, and a signal processing unit 40c determining an operation signal for the imaging device 20, based on a detection result from the detector 30c, and transmitting the operation signal. The detector 30c and the signal processing unit 40c are connected to bidirectionally communicate with each other according to a predetermined wireless communication standard.

The detector 30c includes the clock 41, a third control unit 42c, and a third communication unit 45c, in addition to the configuration of the detector 30 according to the first embodiment described above.

The third control unit 42c controls each unit of the detector 30c. The third control unit 42c transmits determination results from the first determination unit 35 and the second determination unit 36 to the signal processing unit 40c, through the third communication unit 45c.

The third communication unit 45c transmits predetermined information input from the third control unit 42c to the signal processing unit 40c, under the control of the third control unit 42c.

The signal processing unit 40c further includes a display unit 60 and an operating unit 61, in addition to the configuration of the signal processing unit 40 according to the first embodiment.

The display unit 60 displays an image corresponding to image data captured by the imaging device 20 or various information about the operation device 10c, through the first communication unit 43, under the control of the first control unit 44. The display unit 60 includes a liquid crystal display panel, an organic EL display panel, or the like.

The operating unit 61 receives input of various signals to the operation device 10c. The operating unit 61 includes a plurality of switches.

According to the third embodiment of the present disclosure described above, the detector 30c may just transmit information generated upon change in movement of the user's finger to the signal processing unit 40c, so that a circuit may be reduced in size, and power consumption may be reduced.

Furthermore, according to the third embodiment of the present disclosure, wireless power supply may be employed from the signal processing unit 40c to the detector 30c for further reduction in size of the detector 30c, and facilitation of user's operation.

Furthermore, according to the third embodiment of the present disclosure, the detector 30c may be reduced in size for an improved fit for the user, and the fingers may be moved as if the detector 30c is not mounted.

Note that, in the third embodiment of the present disclosure, the detector 30c has the first sensor units 312 each having a square shape orthogonally symmetrical, and the same first sensor units 312 may be used. In this configuration, after the detector 30c is mounted to the thumb and the index finger, the user may input the kind of the external device wirelessly connected to the operation device 10c, or information about the detector 30c (the kind of a mounted finger, or the kind of detection, i.e., pressing or bending), through the operating unit 61 of the signal processing unit 40c or a sound input unit such as a microphone not illustrated. Accordingly, the detector 30c may be further readily mounted.

### Other Embodiments

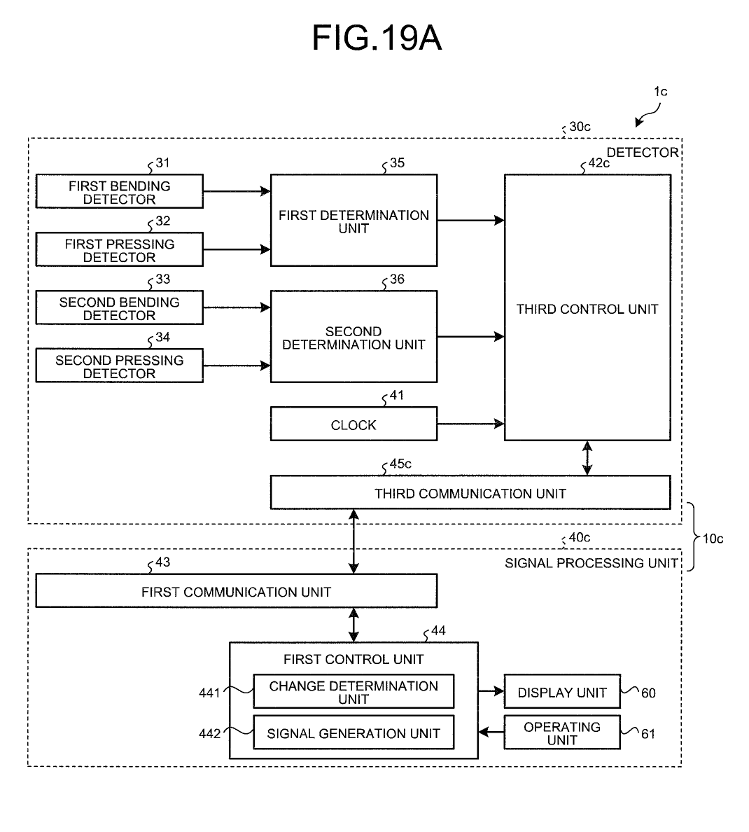

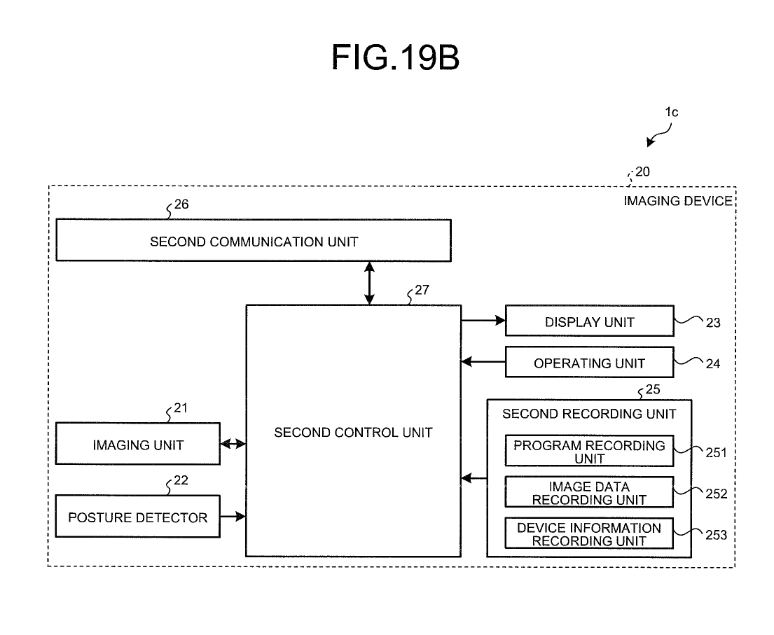

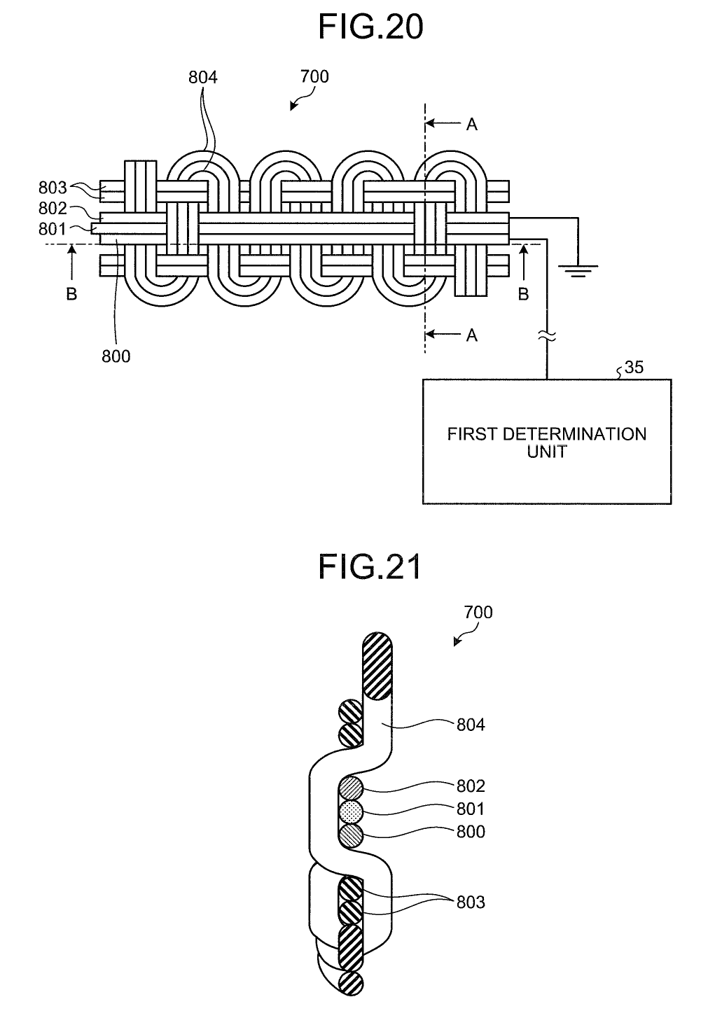

FIG. 20 is a plan view of a first sensor according to a modification of the first to third embodiments of the present disclosure. FIG. 21 is a cross-sectional view taken along a line A-A of FIG. 20. FIG. 22 is a cross-sectional view taken along a line B-B of FIG. 20.

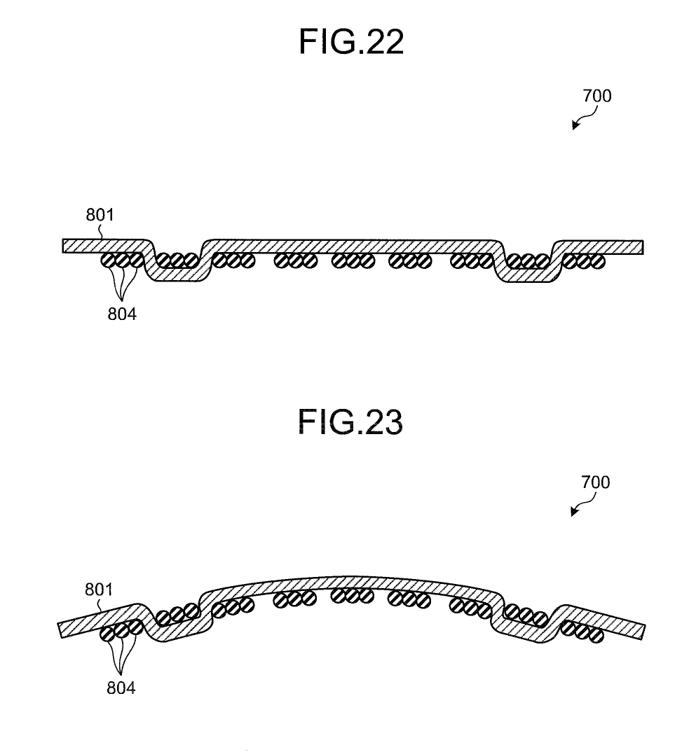

A first sensor unit 700 illustrated in FIGS. 20 to 22 includes a polylactic acid fiber 801, a signal electrode fiber 800 including a conductive fiber and provided opposite the polylactic acid fiber, a GND electrode fibers 802 including a conductive fiber, two insulation fibers 803 provided on either side of the polylactic acid fiber 801, the signal electrode fiber 800, and the GND electrode fiber 802 (specifically, insulation fiber including a resin fiber such as a polylactic acid fiber, or a natural fiber), and warps 804 holding the polylactic acid fiber 801, the signal electrode fiber 800, and the GND electrode fiber 802, and the insulation fibers 803. The polylactic acid fiber 801, the signal electrode fiber 800, and the GND electrode fiber 802 are held in shape by the insulation fibers 803 and the warps 804 mutually woven. Thus, as illustrated in FIG. 23, detection of change in voltage generated by bending and stretching of the polylactic acid fiber 801 in response to an external force allows detection of a change in flexion of a joint and a change in pressing of a tip of a user's finger. Note that weaving is not limited to the present embodiment, and may be changed according to use or position where the fibers are mounted. Furthermore, a configuration including the polylactic acid fiber 801, the signal electrode fiber 800, the GND electrode fiber 802, and the insulation fibers 803 which constitute wefts represents a minimum configuration, and the configurations may be arranged and woven in various manners for forming a fabric. Furthermore, the first sensor unit 700 has a fabric shape having stretchability, and provides an improved fit for the user. Still furthermore, the first sensor unit 700 may be sealed with an insulation material, for example, a resin or rubber. Thus, water resistance may be achieved.

Furthermore, in the first to third embodiments of the present disclosure, the first sensor unit may be formed of a single sheet or single fibers of polyvinylidene fluoride, or may be formed of a rubber sheet material into which inorganic piezoelectric powder is kneaded. A piezoelectric body generating voltage by being deformed in response to an external force may be used to eliminate a battery, and an energy saving system may be provided. Furthermore, the first sensor unit may be formed of a stretchable conductive material to detect a change in electrical resistance caused by the elasticity, as an electrical signal (voltage or current).

Furthermore, in the first to third embodiments of the present disclosure, the imaging device has been exemplified as the external device, but the external device is not limited thereto, and for example, an endoscope may be exemplified as the external device. In this case, the endoscope may be configured so that electronic zoom or optical zoom, or please/capture of a still image (capture of still image) is performed, based on a signal output upon pressing or flexion of an operation device with a thumb or index finger of an operator of the endoscope. Thus, an image capture function of the endoscope may be controlled, while inserting the endoscope or operating a treatment tool such as an electrosurgical knife.

Furthermore, in the first to third embodiments of the present disclosure, a manipulator or the like used in a thermostatic chamber may be employed as the external device.

Furthermore, some embodiments of the present application has been described in detail with reference to the drawings, but these are provided by way of examples, and the present disclosure may be carried out in other forms to which various modifications and improvements are made based on the knowledge of those skilled in the art, including the modes described in “SUMMARY OF THE DISCLOSURE”.

Still furthermore, in the description of the flowcharts in the present specification, expressions such as “first”, “next”, and “then” are used to make the order of processing of the steps clear, but the order of the processing for carrying out the above embodiments is not uniquely defined by these expressions. That is, the order of processing in the flowcharts described in the specification may be modified as long as there is no inconsistency.

Furthermore, processing algorithms described using the flowcharts in the present specification may be described as programs. Each of the programs may be recorded in a storage unit in a computer, or recorded in a computer-readable recording medium. Recording of the program in the storage unit or the recording medium may be performed upon shipping of the computer or the recording medium as a product, or may be performed by download via a communication network.

The present disclosure, as has been described above, may include various embodiments which are not described in the specification, and may be variously modified in design or the like within the scope of the technical idea specified by the claims.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An operation device comprising:
a detector adapted for being mounted at least to a thumb or an index finger, and configured to detect a change in flexion with time at a joint and a change in pressing with time at a tip of the thumb or the index finger wearing the detector;
a recording unit configured to record operation information representing association between: each of the change in flexion and the change in pressing; and a plurality of operations performed by any of the thumb and the index finger on an external device;
a determination unit configured to determine the operation included in the operation information recorded in the recording unit, based on the change in flexion and the change in pressing; and
a control unit configured to generate a control signal for causing the external device to perform a predetermined operation, according to the determined operation, and transmit the control signal to the external device.

2. The operation device according to claim 1, wherein
the detector includes
mounted portions having a strip shape adapted for being mounted to the thumb or the index finger, and
sensor units layered on the mounted portions to detect the change in flexion and the change in pressing, respectively.

3. The operation device according to claim 2, wherein
each of the sensor units includes a piezoelectric sheet having flexibility to generate an electrical signal in response to an external force, and
each of the change in flexion and the change in pressing is represented by a change in the electrical signal with time.

4. The operation device according to claim 2, wherein
each of the sensor units includes a piezoelectric fiber having flexibility to generate an electrical signal in response to an external force, and
each of the change in flexion and the change in pressing is represented by a change in the electrical signal with time.

5. The operation device according to claim 2, wherein
each of the sensor units includes a conductive material having stretchability to change a resistance value according to elongation and contraction, and
each of the change in flexion and the change in pressing is represented by a change in the resistance value with time.

6. The operation device according to claim 1, wherein
the plurality of operations are any of a push operation, a rotation operation, and a touch operation.

7. An operation system comprising:
an operation device including:
a detector adapted for being mounted at least to a thumb or an index finger, and configured to detect a change in flexion with time at a joint and a change in pressing with time at a tip of the thumb or the index finger wearing the detector;
a recording unit configured to record operation information representing association between: the change in flexion and the change in pressing; and a plurality of operations performed by any of the thumb and the index finger on an external device;
a determination unit configured to determine the operation included in the operation information recorded in the recording unit, based on the change in flexion and the change in pressing; and
a control unit configured to generate a control signal for causing the external device to perform a predetermined operation, according to the determined operation, and transmit the control signal to the external device; and
an imaging device configured to image an object and generate image data of the object, the imaging device performing an operation according to the control signal transmitted from the operation device.
